(19) United States
(12) Patent Application Publication
(10) Pub. No.: US 2026/0044471 A1
(43) Pub. Date: Feb. 12, 2026

(54) GEARBOXES FOR COMMUNICATING DATA BETWEEN ROOT COMPLEXES AND ENDPOINTS

(71) Applicant: MARVELL ASIA PTE LTD, Singapore (SG)

(72) Inventor: Amit SAXENA, Pleasanton, CA (US)

(21) Appl. No.: 19/293,529

(22) Filed: Aug. 7, 2025

Related U.S. Application Data
(60) Provisional application No. 63/681,031, filed on Aug. 8, 2024.

(51) Int. Cl. G06F 13/42

(52) U.S. Cl. CPC G06F 13/4265

(57) ABSTRACT

An example gearbox for connecting between a root complex and an endpoint in a computing device, includes a first port configured to connect to the root complex, a second port configured to connect to the endpoint, a first physical layer connected to the first port and a second physical layer connected to the second port, and a first data link layer and a second data link layer, the first data link layer connected between the second data link layer and the first physical layer, and the second data link layer connected between the first data link layer and the second physical layer. The first physical layer, the first data link layer, the second physical layer, and the second data link layer are configured to form one or more lanes for communicating data between the root complex and the endpoint.

### CROSS-REFERENCE TO RELATED APPLICATIONS

This application claims the benefit of U.S. Provisional Application No. 63/681,031, filed on Aug. 8, 2024. The entire disclosure of the application referenced above is incorporated herein by reference.

### FIELD

The present disclosure relates to gearboxes for communicating data between root complexes and endpoints in computing systems.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Computing systems often communicate data between hardware components. With such data communication, the computing systems may follow a particular communication standard, such as Peripheral Component Interconnect Express (PCIe) for establishing a point-to-point connection between different hardware components. In a PCIe topology, data can be communicated via separate serial links between a root complex (e.g., a host) and one or more endpoints. The root complex is a device that connects a central processing unit (CPU) and memory in a computing system to the one or more endpoints. The root complex controls other PCIe components in the hierarchy. The endpoints are peripheral devices in the computing system that provide specific functions, such as a nonvolatile memory (NVM) express solid-state drive (SSD), a network interface controller (NIC), a graphics processing unit (GPU), an add-in memory card, etc.

The root complex may be directly connected to an endpoint or connected to one or more endpoints via another PCIe component. Specifically, a switch can be employed to connect the root complex to multiple endpoints over a single PCIe link on the root complex side and multiple PCIe links on the endpoint side. With this configuration, each endpoint is associated with its own PCIe link, and traffic flows between the root complex side and the PCIe links on the endpoint side via the switch. Alternatively, a retimer can be employed to connect the root complex to one or more endpoints via a one-to-one link connectivity. Specifically, the retimer implements independent PCIe links for each endpoint. As such, if two endpoints are employed, the retimer connects the root complex to the first endpoint over a single PCIe link on the root complex side and a single PCIe link on the endpoint side, and connects the root complex to the second endpoint over another single PCIe link on the root complex side and another single PCIe link on the endpoint side. With this configuration, traffic flow between the root complex side and each endpoint through the retimer and each independent PCIe link, without crossing between the independent PCIe links.

### SUMMARY

An example gearbox for connecting between a root complex and an endpoint in a computing device, includes a first port configured to connect to the root complex, a second port configured to connect to the endpoint, a first physical layer connected to the first port and a second physical layer connected to the second port, and a first data link layer and a second data link layer, the first data link layer connected between the second data link layer and the first physical layer, and the second data link layer connected between the first data link layer and the second physical layer. The first physical layer, the first data link layer, the second physical layer, and the second data link layer are configured to form one or more lanes for communicating data between the root complex and the endpoint.

In some examples, the first physical layer and the first data link layer form a first link, and the second physical layer and the second data link layer form a second link independent from the first link.

In some examples, the first physical layer includes a physical coding sublayer (PCS) connected to the first port and a media access control (MAC) sublayer connected to the first data link layer, and the second physical layer includes a PCS connected to the second port and a MAC sublayer connected to the second data link layer.

In some examples, the PCS of the first physical layer is configured to provide a data interface between the first port and the MAC sublayer, and the PCS of the second physical layer is configured to provide a data interface between the second port and the MAC sublayer of the second physical layer.

In some examples, the MAC sublayer of the first physical layer includes data path modules between the PCS of the first physical layer and the first data link layer, and a first Link Training and Status State Machine (LTSSM) module, and the MAC sublayer of the second physical layer includes data path modules between the PCS of the second physical layer and the second data link layer, and a second LTSSM module.

In some examples, the first data link layer includes a first finite state machine (FSM) module configured to connect with the second link, and the second data link layer includes a second FSM module configured to connect with the first link.

In some examples, the second FSM module is configured to detect a link down condition on the second link, and in response to the link down condition, the first LTSSM module is configured to create a link down condition on the first link.

In some examples, the first FSM module is configured to detect a link down condition on the first link, and in response to the link down condition, the second LTSSM module is configured to enter a disabled state.

In some examples, the gearbox includes a control module configured to determine whether a bandwidth on the first link and a bandwidth on the second link is the same, and in response to the bandwidth on the first link and the bandwidth on the second link being the same, allow a Data Link Layer Packet (DLLP) to pass between the root complex and the endpoint via the gearbox.

In some examples, the control module is configured to prevent the DLLP to pass between the root complex and the endpoint via the gearbox in response to the bandwidth on the first link and the bandwidth on the second link being different.

In some examples, the gearbox includes a control module configured to detect a transient error condition on one of the first link or the second link, and in response to the transient error condition, send a Negative Acknowledgement (NAK) signal on the other one of the first link or the second link.

In some examples, the gearbox includes a control module configured to enable a low power state for one of the first link or the second link if no Transaction Layer Packets (TLPs) are present in the one of the first link or the second link.

In some examples, the control module is configured to initiate a low power state request for the root complex or the endpoint connectable to the other one of the first link or the second link, and in response to the low power state request being rejected, transition the one of the first link or the second link back to an active state.

In some examples, the control module is configured to exit the low power state in response to a request for the root complex or the endpoint.

In some examples, a bandwidth on the first link and a bandwidth on the second link are the same.

In some examples, a data rate at the first port is different than a data rate at the second port.

In some examples, a data rate at the first port is the same as a data rate at the second port.

In some examples, the gearbox does not include a transaction layer.

In some examples, the gearbox is configured to communicate data, compliant with a Peripheral Component Interconnect Express (PCIe) standard, between the root complex and the endpoint.

An example computing system for communicating data compliant with a Peripheral Component Interconnect Express (PCIe) standard, includes a root complex configured to connect to a processor and memory, an endpoint and a gearbox connected between the root complex and the endpoint. The gearbox includes a first port connected to the root complex and a second port connected to the endpoint, the gearbox configured to communicate data, compliant with the Peripheral Component Interconnect Express (PCIe) standard, between the root complex and the endpoint.

In some examples, the gearbox includes a first physical layer connected to the first port, a second physical layer connected to the second port, a first data link layer and a second data link layer, the first data link layer is connected between the second data link layer and the first physical layer, the second data link layer is connected between the first data link layer and the second physical layer, and the first physical layer, the first data link layer, the second physical layer, and the second data link layer are configured to form one or more lanes for communicating data between the root complex and the endpoint.

In some examples, the first physical layer and the first data link layer form a first link, and the second physical layer and the second data link layer form a second link independent from the first link.

In some examples, the first physical layer includes a physical coding sublayer (PCS) connected to the first port and a media access control (MAC) sublayer connected to the first data link layer, the second physical layer includes a PCS connected to the second port and a MAC sublayer connected to the second data link layer, the PCS of the first physical layer is configured to provide a data interface between the first port and the MAC sublayer, and the PCS of the second physical layer is configured to provide a data interface between the second port and the MAC sublayer of the second physical layer.

In some examples, the MAC sublayer of the first physical layer includes data path modules between the PCS of the first physical layer and the first data link layer, and a first Link Training and Status State Machine (LTSSM) module, the MAC sublayer of the second physical layer includes data path modules between the PCS of the second physical layer and the second data link layer, and a second LTSSM module, the first data link layer includes a first finite state machine (FSM) module configured to connect with the second link, and the second data link layer includes a second FSM module configured to connect with the first link.

In some examples, the second FSM module is configured to detect a link down condition on the second link, and in response to the link down condition, the first LTSSM module is configured to create a link down condition on the first link.

In some examples, the first FSM module is configured to detect a link down condition on the first link, and in response to the link down condition, the second LTSSM module is configured to enter a disabled state.

In some examples, the gearbox further includes a control module configured to determine whether a bandwidth on the first link and a bandwidth on the second link is the same, and in response to the bandwidth on the first link and the bandwidth on the second link being the same, allow a Data Link Layer Packet (DLLP) to pass between the root complex and the endpoint via the gearbox.

In some examples, the control module is configured to prevent the DLLP to pass between the root complex and the endpoint via the gearbox in response to the bandwidth on the first link and the bandwidth on the second link being different.

In some examples, the gearbox further includes a control module configured to detect a transient error condition on one of the first link or the second link, and in response to the transient error condition, send a Negative Acknowledgement (NAK) signal on the other one of the first link or the second link.

In some examples, the gearbox further includes a control module configured to enable a low power state for one of the first link or the second link if no Transaction Layer Packets (TLPs) are present in the one of the first link or the second link, initiate a low power state request for the root complex or the endpoint connected to the other one of the first link or the second link, and in response to the low power state request being rejected, transition the one of the first link or the second link back to an active state.

In some examples, the control module is configured to exit the low power state in response to a request for the root complex or the endpoint.

In some examples, a bandwidth on the first link and a bandwidth on the second link are the same.

In some examples, a data rate at the first port is different than a data rate at the second port.

In some examples, a data rate at the first port is the same as a data rate at the second port.

In some examples, the gearbox does not include a transaction layer.

An example computing system for communicating data, includes a root complex configured to connect to a processor and memory, an endpoint and a gearbox connected between the root complex and the endpoint. The gearbox includes a first port connected to the root complex and a second port connected to the endpoint, a first physical layer connected to the first port and a second physical layer connected to the second port, and a first data link layer and a second data link layer, the first data link layer connected between the second data link layer and the first physical layer, and the second data link layer connected between the first data link layer and the second physical layer. The first physical layer, the first data link layer, the second physical layer, and the second data link layer are configured to form one or more lanes for communicating data between the root complex and the endpoint.

In some examples, a data rate at the first port is different than a data rate at the second port.

In some examples, a data rate at the first port is the same as a data rate at the second port.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF DRAWINGS

FIG. 1 is a functional block diagram of an example computing system including a root complex, an endpoint, and a gearbox connecting between the root complex and the endpoint, in accordance with an embodiment of the present disclosure.

FIG. 2 is a functional block diagram of another example computing system including a gearbox having two independent links each implemented with a physical layer and a data link layer, in accordance with an embodiment of the present disclosure.

FIG. 3 is a functional block diagram of an example gearbox including physical layers each having a physical coding sublayer and a media access control sublayer, in accordance with an embodiment of the present disclosure.

FIGS. 4A-B are functional block diagrams of another example gearbox, in accordance with an embodiment of the present disclosure.

FIG. 5 is a flow chart of a control process for addressing link down conditions on downstream link segments in a gearbox, in accordance with an embodiment of the present disclosure.

FIG. 6 is a flow chart of a control process for addressing link down conditions on upstream link segments in a gearbox, in accordance with an embodiment of the present disclosure.

FIG. 7 is a flow chart of a control process for addressing transient error conditions on upstream link segments in a gearbox, in accordance with an embodiment of the present disclosure.

FIG. 8 is a flow chart of a control process for addressing transient error conditions on downstream link segments in a gearbox, in accordance with an embodiment of the present disclosure.

FIG. 9 is a flow chart of a control process for addressing bandwidth mismatch scenarios in a gearbox, in accordance with an embodiment of the present disclosure.

FIG. 10 is a flow chart of a control process for addressing power state change scenarios in a gearbox, in accordance with an embodiment of the present disclosure.

In the drawings, reference numbers may be reused to identify similar and/or identical elements.

### DESCRIPTION

In computing systems, data transfer routinely occurs between hardware components. The speed at which data is transferred is a crucial metric for performance, with higher speeds indicating faster data exchange. In some examples, the computing systems may follow a particular communication standard, such as Peripheral Component Interconnect Express (PCIe), etc. for establishing a point-to-point connection for data transfer between different hardware components. PCIe is a high-speed standard used for connecting a central processing unit (CPU) and memory with endpoints (e.g., devices, such as graphics cards, sounds cards, solid-state drives, add in memory cards, network interface controllers, etc.).

In a PCIe topology, data can be communicated via separate serial links between a root complex (e.g., a host) and one or more endpoints. The root complex connects the CPU and memory to the one or more endpoints. In many cases, a switch or a retimer is employed to connect the root complex to multiple endpoints. The components in the PCIe topology may include different implementation layers (e.g., in a protocol stack) depending on their functionality. Such implementation layers are defined in the PCIe specification so that the evolution in data rates does not require whole redesign of the PCIe components.

Specifically, the PCIe implementation layers are defined as a physical layer, a data link layer and a transaction layer. The physical layer generally manages low-level electrical signaling and data transmission (e.g., encoding, decoding, framing, clock recovery, etc.) over links between PCIe components. The data link layer generally manages data flow control, error detection (CRC), link management, etc. ensuring reliable transmission of data packets between PCIe components. The transaction layer generally manages actual data transfer between PCIe components and routing of data within the stack. For example, the transaction layer can break down data into Transaction Layer Packets (TLPs), which are then passed down to the data link layer for processing. Generally, a root complex and an end point have a single set of a physical layer, a data link layer and a transaction layer. A switch has multiple sets of physical layers, data link layers and transaction layers, with one set on the root complex side, two or more sets on the endpoint side (one for each endpoint device connected to the switch), and a switch interconnect therebetween. A retimer has at least two sets of physical layers.

As hardware components in computing system move to higher bandwidth capabilities, switches and retimers in the PCIe topology may be inept to accommodate such higher data transfer rates with low latency while maintaining maximum available bandwidth. For example, retimers limit operation to the highest common data rate of the connecting hardware components. As an example, CPUs typically migrate to a higher bandwidth as the PCIe specification evolves, whereas endpoint devices tend to move slower to the higher bandwidth. For instance, if a CPU with two PCIe links moves to a newer version of the PCIe specification supporting a higher bandwidth (e.g., a data rate of 64 GT/s per lane) but endpoint devices each with a single PCIe link remain at an older version of the PCIe specification having a lower bandwidth (e.g., a data rate of 32 GT/s per lane), the retimer between the CPU and the endpoint device operates at the lower bandwidth of the endpoint device even though the CPU PCIe link is capable of operating at the higher bandwidth. In such examples, the CPU having 8 lanes per PCIe link has a bandwidth of 1024 G (2×(2×4×64 G)), whereas two endpoint devices each with 4 lanes per PCIe link have a bandwidth of 512 G (2×(2×4×32 G)). As such, due to the limitations of the retimer, the CPU bandwidth is limited to the lower bandwidth of the endpoint devices, thereby underutilizing the CPU's increased performance. However, due to its simplistic design, the retimer offers a low latency for data transfer between the CPU and the endpoint devices.

A similar scenario is realized when a switch is utilized in the PCIe topology. Specifically, as a CPU migrates to a newer version of the PCIe specification supporting a higher bandwidth and endpoint devices remain at an older version of the PCIe specification having a lower bandwidth, the CPU bandwidth is again limited to the lower bandwidth of the endpoint devices when a two-port switch is employed. For instance, a CPU having one PCIe link with lanes 8 has a bandwidth of, for example, 1024 G (8×2×64 G)), whereas two endpoint devices each with 4 lanes per PCIe link has a bandwidth of, for example, 512 G (2×(2×4×32 G)). To address this issue, a solution may be to move to a 5-port switch in which the CPU having one PCIe link with lanes 8 is connected to 4 endpoint devices each with 4 lanes per PCIe link. In this scenario, the bandwidth of the CPU remains at 1024 G and the bandwidth of the endpoint devices increases to 1024 G (4×(2×4×32 G)). However, with this approach, the switch experiences a latency penalty due to the increased ports causing the switch to perform more functions at the transaction layer. As such, while the switch may by used to bridge the bandwidth difference between the CPU and the endpoint devices, the time it takes data to travel between the CPU and the endpoint devices increases. This results in performance loss in the system.

Additionally, performance impact may increase over time. For example, as data rates increase for hardware components (e.g., the CPU), additional latency is introduced due to the switch causing greater performance impact. For instance, when data rates increase, impact of larger increased interconnect latency of the switch is experienced more significantly and larger buffer at the endpoints and the root complex (e.g., increased area and an increased cost) are required to hide the interconnect latency and achieve full bandwidth capabilities.

The example computing systems disclosed herein utilize unique gearboxes for connecting between a root complex and one or more endpoint devices. Such gearboxes are capable of bridging bandwidth differences between a faster CPU and slower endpoint devices (e.g., different data rates on each side of the gearboxes), while also experiencing a minimal amount of latency during data transfer. As such, the gearboxes provide the benefits of a switch (e.g., bridging bandwidth differences) and a retimer (e.g., low latency) without the drawbacks associates with the switch (e.g., higher latency) and the retimer (bandwidth limitations). Thus, the gearboxes offer a superior substitute for both switches and retimers in computing systems follow a particular communication standard, such as PCIe.

The examples disclosed herein provide gearboxes implemented with multiple sets of PL and DL and multiple independent links. As such, each link implements its own set of PL and DL independent of the other link(s). With this approach, the independent links can support new versions of the PCIe specification (e.g., a Gen7 line rate of 128 GT/s per lane, etc.) or other communication standards. For example, the gearboxes herein may be implemented with the Compute Express Link (CXL) communication standard since CXL uses PCIe physical and data link layers. For instance, CXL is often used for coherent system memory, which is highly sensitive to latencies (e.g., introduced when a switch is employed for data transfer). Thus, the gearboxes provide improved solutions as substitutes for both CXL/PCIe switches and CXL/PCIe retimers.

Additionally, the example gearboxes herein provide further benefits of over switches in data transfer. For example, due to their simplistic design of sets (e.g., two sets, etc.) of PL and DL and independent links (e.g., two links), the gearboxes require significantly less area than switches. With this reduction in area, the gearboxes will be less costly to implement than switches.

The following examples describe topologies utilizing gearboxes in computing systems following a communication standard, such as PCIe, CXL etc. for establishing a point-to-point connection for data transfer between different hardware components.

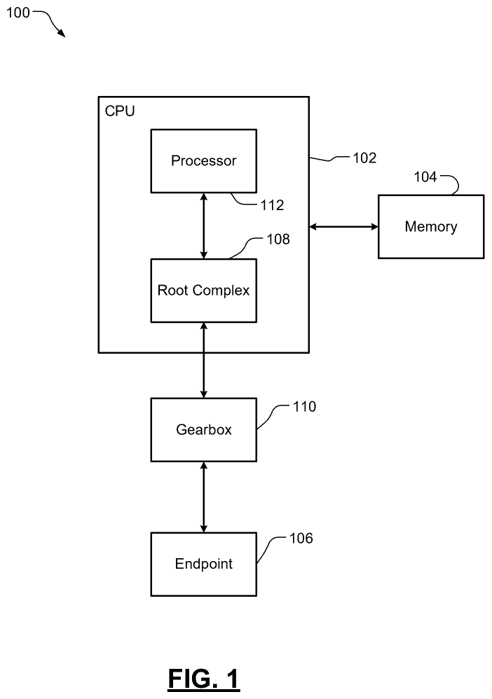

For example, FIG. 1 shows a computing system 100 for communicating data between hardware components in a computing device. For instance, the computing system 100 of FIG. 1 generally includes a CPU 102, memory 104, and an endpoint 106, where data can be communicated between the CPU 102 and/or memory 104 and the endpoint 106. In the example of FIG. 1, the communication of data is compliant with and described relative to the PCIe standard. However, it should be appreciated that the communication of data with respect to the computing system 100 (or any other system or component herein) may be compliant another suitable standard, such as the CXL standard.

In the example of FIG. 1, the CPU 102 and the memory 104 may be any suitable processor and memory circuit in the computing device (e.g., a server, a personal computer, a laptop, etc.). For example, the memory 104 may include one or more volatile memory circuits, such as a static random access memory circuit or a dynamic random access memory circuit. In FIG. 1, the CPU 102 includes a processor 112. In such examples, the processor 112 may include a single processor circuit or multiple processor circuits for executing executable instructions stored in, for example, the memory 104. The endpoint 106 may be any suitable device associated with the computing device. For example, the endpoint 106 may include a graphics card (e.g., graphics processing unit in the card), a sounds card, a solid-state drive, an add-in memory card, a network interface controller, and/or any other peripheral device in the computing system 100 that provides specific functions. While the computing system 100 of FIG. 1 is shown as including one endpoint, it should be appreciated that the computing system 100 or other computing systems herein may include multiple endpoints (e.g., devices) in communication with the CPU 102.

The computing system 100 further includes a root complex 108 and a gearbox 110. The root complex 108 may be integrated into the CPU 102 as shown in FIG. 1 or external to the CPU 102. The root complex 108 functions as a bridge between the CPU 102 (more specifically, the processor 112) and a PCIe framework, thereby connecting the CPU 102 and the memory 104 with the endpoint 106 and/or other PCIe devices in the computing system 100. The root complex 108 performs various functions, including control of the endpoint 106 and/or other PCIe devices in the hierarchy. For instance, the root complex 108 may detect and identify the endpoint 106 connected to a communication bus (e.g., a PCie bus) in the computing device, route traffic between the CPU 102, the memory 104, and the endpoint 106, etc.

As shown, the gearbox 110 is connected between the root complex 108 and the endpoint 106. For example, although not shown in FIG. 1, the gearbox 110 includes a port for connecting to the root complex 108 and another port for connecting to the endpoint 106. In such examples, each port may include a Physical Medium Attachment (PMA) transmitter (Tx) and a PMA receiver (Rx). While the computing system 100 of FIG. 1 is shown as including one gearbox, it should be appreciated that the computing system 100 or other computing systems herein may include multiple gearboxes in some example embodiments.

The gearbox 110 communicates data, compliant with the PCIe standard, between the root complex 108 and the endpoint 106. For example, the root complex 108 may initiate a data request (e.g., a Memory Read Request (MRd), etc.), which is passed through the gearbox 110 to the endpoint 106. Then, after receiving the data request, the endpoint 106 may return a reply with data to the root complex 108 (via the gearbox 110). In other examples, the endpoint 106 may initiate a data request, which is passed through the gearbox 110 to the root complex 108. Then, after receiving the data request, the root complex 108 may return a reply with data (e.g., from the memory 104) to the endpoint 106. In some instances, data may be passed between the endpoint 106 and another endpoint. In such examples, the endpoint 106 may initiate a data request, which is passed through the gearbox 110 to the root complex 108. Then, after receiving the data request, the root complex 108 passes the request to (or generates another data request for) another endpoint (e.g., a completer endpoint) via the gearbox 110 or another gearbox. Next, the completer endpoint may return a reply with data to the root complex 108 via the gearbox 110 or the other gearbox. Then, the root complex 108 passes the reply to (or generates another reply for) the endpoint 106 via the gearbox 110.

The gearbox 110 may include various layers (not shown) for facilitating the transfer of data between the root complex 108 and the endpoint 106. For instance, the gearbox 110 may include physical layers and data link layers in protocol stacks (e.g., PCIe protocol stacks). In such examples, the physical layers generally manage low-level electrical signaling and data transmission (e.g., encoding, decoding, framing, clock recovery, etc.) over links with the root complex 108 and the endpoint 106. The data link layers generally manage data flow control, error detection (CRC), link management, etc. ensuring reliable transmission of data packets between the root complex 108 and the endpoint 106.

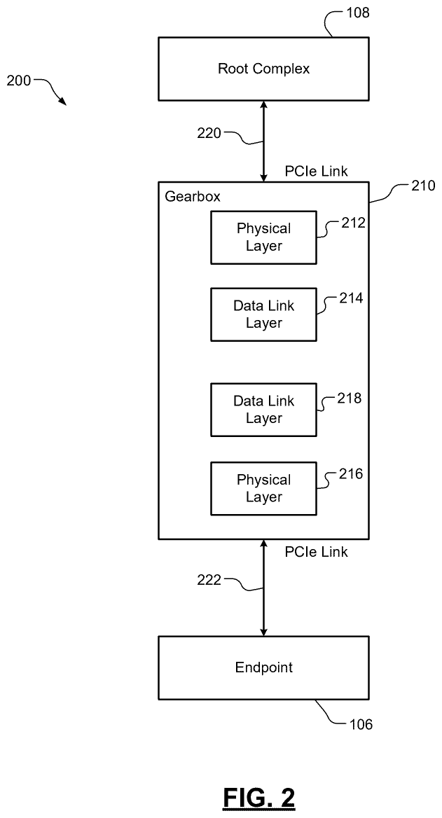

For example, FIG. 2 shows a computing system 200 similar to the computing system 100 but with a gearbox 210 including physical layers and data link layers. In FIG. 2, the gearbox 210 is connected between the root complex 108 of FIG. 1 and the endpoint 106 of FIG. 1. The gearbox 210 of FIG. 2 function in a similar manner as other gearboxes herein.

In the example of FIG. 2, the gearbox 210 includes a first set of a physical layer 212 and a data link layer 214 and a second set of a physical layer 216 and a data link layer 218. With this configuration, the physical layer 212 connects to or includes a port (not shown) for connecting with the root complex 108, and data link layer 214 is connected between the data link layer 218 and the physical layer 212. Additionally, the physical layer 216 connects to or includes another port (not shown) for connecting with the endpoint 106, and data link layer 218 is connected between the data link layer 214 and the physical layer 216. In such examples, each port may include a PMA Tx and a PMA receiver Rx, as explained above.

In FIG. 2, the gearbox 210 implements two links 220, 222 independent of each other. In this example, the link 220 (e.g., a PCIe link) connects between the root complex 108 and the gearbox 210, and the link 222 (e.g., a PCIe link) connects between the endpoint 106 and the gearbox 210. Each link 220, 222 functions independently, such that each link can negotiate their own parameters (e.g., data rate, etc.). In this example, the link 220 is formed with the physical layer 212 and the data link layer 214 for communicating with the root complex 108, and the link 222 is formed with the physical layer 216 and the data link layer 218 for communicating with the endpoint 106.

In various examples, the links 220, 222 may include one or more lanes for communicating data between the root complex 108 and the endpoint 106. In such examples, each lane includes two wires for transmitting and receiving data. For example, in the link 220, the physical layer 212 and the data link layer 214 may form one or more lanes. Additionally, in the link 222, the physical layer 216 and the data link layer 218 may form one or more lanes. The number of lanes associated with the link 220 and the number of lanes associated with the link 222 may be the same or different.

In the example of FIG. 2, the gearbox 210 is implemented without a transaction layer. Specifically, neither link 220, 222 is associated with a transaction layer. In other words, protocol stacks associated with the links 220, 222 include only the physical layers 212, 216 and the data link layers 214, 218, respectively. The protocol stacks do not include transactions layers. With this implementation, the gearbox 210 can experience reduced latency as compared to other PCIe devices (e.g., switches). For example, because no transaction layer is present, the gearbox 210 is not implemented with transaction layer buffers, such as store-and-forward buffers, virtual channel (VC) buffers, etc. Such transaction layer buffers often introduce latency as entire data packets in a request or reply must be received and processed before forwarding of the request or reply can occur.

In the example of FIG. 2, a bandwidth on the link 220 and a bandwidth on the link 222 are the same, such as 512 G, 1024 G, 2048 G, etc. For example, because the gearbox 210 does not include transaction layer buffers, the gearbox 210 cannot throttle transaction layer packets that are received from the root complex 108 or the endpoint 106. As such, bandwidth on each of the links 220, 222 matches so that the transaction layer packets that pass link layer checks (as further explained below) on a RX side of the data link layers 214, 216 can be sent out on a TX side of the data link layers 214, 216 without throttling.

Additionally, data rates on the links 220, 222 may be the same or different, as long as the bandwidth on each link is the same. For example, a data rate at a port connecting to the root complex 108 may be the same or different than a data rate at a port connecting to the endpoint 106. For example, and as referenced above, a CPU connected with the root complex 108 may migrate to a higher bandwidth configuration having a higher data rate (e.g., 64 GT/s per lane, 128 GT/s per lane, etc.) than the endpoint 106 with a lower data rate (e.g., 32 GT/s per lane). With this approach, the gearbox 210 can bridge a bandwidth difference on the root complex side (e.g., a faster host device) and the endpoint side (e.g., with a slower endpoint or endpoints) by, for exampling connecting addition endpoints, adding lanes on the endpoint side, etc. In other examples, the CPU connected with the root complex 108 and the endpoint 106 may have the same bandwidth with the same data rate (e.g., 32 GT/s per lane, 64 GT/s per lane, 128 GT/s per lane, etc.).

In some examples, the physical layers 212, 216 of the gearbox 210 may be broken down into multiple sublayers. For instance, each physical layer 212, 216 may include a physical coding (PCS) sublayer, a media access control (MAC) sublayer, etc.

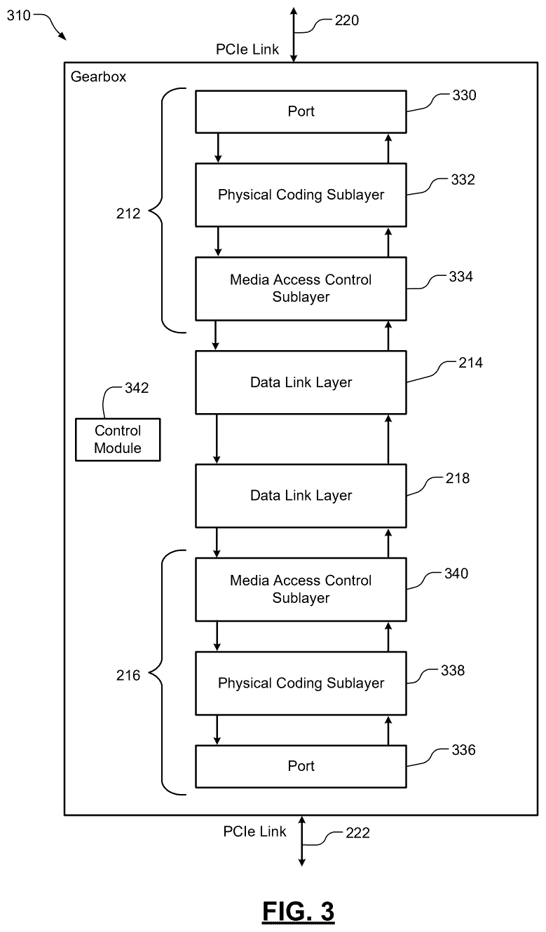

As one example, FIG. 3 shows a gearbox 310 similar to the gearbox 210 of FIG. 2, but with the physical layers 212, 216 having multiple sublayers. While not shown in FIG. 3, the gearbox 310 can be connected between a root complex (e.g., the root complex 108 of FIG. 1) and one or more endpoints (e.g., the endpoint 106 of FIG. 1). The gearbox 310 of FIG. 3 may function in a similar manner as other gearboxes herein.

In the example of FIG. 3, the gearbox 310 includes the physical layers 212, 216 and the data link layers 214, 218. The physical layer 212 and the data link layer 214 corresponding with the link 220 (e.g., a PCIe link) connecting between the root complex and the gearbox 310, and the physical layer 216 and the data link layer 218 corresponding with the link 222 (e.g., a PCIe link) connecting between the endpoint(s) and the gearbox 310, as explained above. The links 220, 222 are independent of each other.

As shown in FIG. 3, the physical layers 212, 216 each include a port, a PCS sublayer and a MAC sublayer. Specifically, in FIG. 3, the physical layer 212 includes a port 330, a PCS sublayer 332 connected to the port 330 and a MAC sublayer 334 connected to the data link layer 214. Similarly, the physical layer 216 includes a port 336, a PCS sublayer 338 connected to the port 336 and a MAC sublayer 340 connected to the data link layer 218. With this configuration, the PCS sublayer 332 provides a data interface between the port 330 and the MAC sublayer 334, and the PCS sublayer 338 provides a data interface between the port 336 and the MAC sublayer 340.

In FIG. 3, each port 330, 336 may be a sublayer including a PMA Tx and a PMA Rx. In such examples, the port 330 interfaces with the root complex and the port 336 interfaces with the endpoint. Additionally, each PCS sublayer 332, 338 facilitates the conversion of data into a format suitable for transmission over its corresponding PMA sublayer and MAC sublayer. For example, and as further described herein, each PCS sublayer 332, 338 generally performs data encoding and decoding, alignment marker insertion and removal, and lane block synchronization. Each MAC sublayer 334, 340 manages access to its corresponding link, and generally performs framing, data encoding and decoding, flow control, error detection, etc. In such examples, the data link layer 214 and the physical layer 212 (with the port 330, the PCS sublayer 332, and the MAC sublayer 334) are part of a protocol stack, while the data link layer 218 and the physical layer 216 (with the port 336, the PCS sublayer 338, and the MAC sublayer 340) are part of another protocol stack.

Additionally, the gearbox 310 includes a control module 342. In the example of FIG. 3, the control module 342 may include a control and status register (CSR) for storing information about a state of the control module 342 and controlling rate matching for data passing through the data link layers 214, 218. For example, the CSR (or more generally the control module 342) can store interrupt statuses, operating modes, flags, etc. and control enablement/disablement of interrupts, change operating modes, set flags, etc. Further, in some embodiments, the control module 342 can detect errors on the data link layers 214, 218 and/or the physical layers 212, 216, as further explained below.

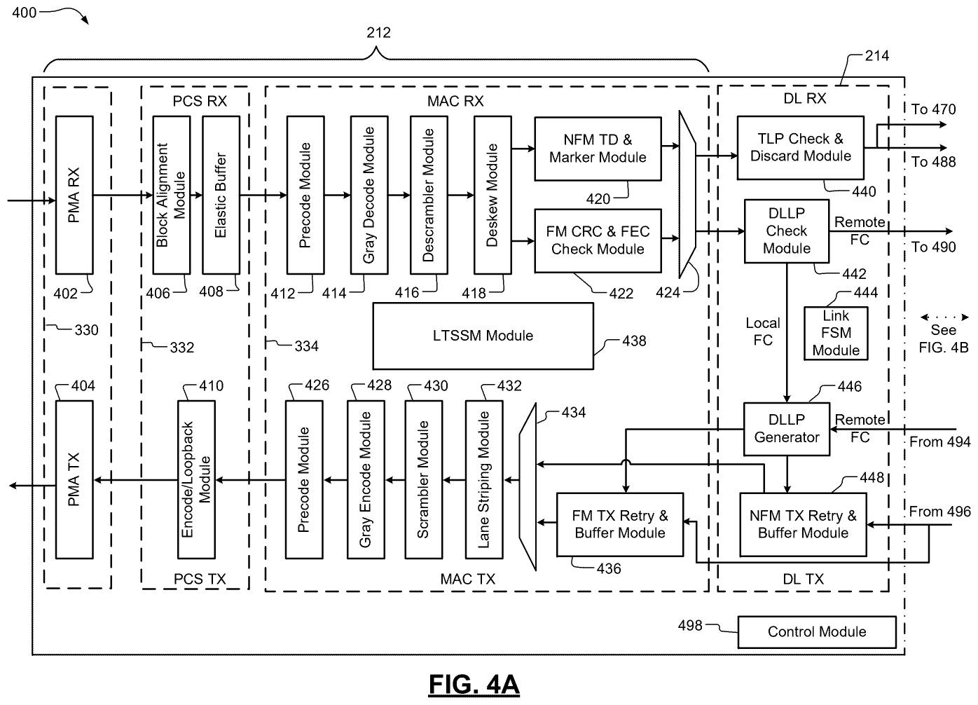

FIGS. 4A-B show another example gearbox 400 for connecting between a root complex and one or more endpoints. The gearbox 400 is similar to the gearbox 310 of FIG. 3, but include various modules for implementing data transfer between the root complex and the endpoint(s). The gearbox 400 of FIGS. 4A-B function in a similar manner as other gearboxes herein.

In FIGS. 4A-B, the gearbox 400 includes the physical layers 212, 216 and the data link layers 214, 218 of FIG. 3. Specifically, in FIG. 4A, the physical layer 212 includes the port 330, the PCS sublayer 332 and the MAC sublayer 334. Additionally, in FIG. 4B, the physical layer 216 includes the port 336, the PCS sublayer 338 and the MAC sublayer 340. The physical layer 212 and the data link layer 214 form an independent link with a root complex (not shown in FIG. 4A), and the physical layer 216 and the data link layer 218 form another independent link with an endpoint (not shown in FIG. 4B).

The physical layers 212, 216 and the data link layers 214, 218 includes similar modules along data receiving (RX) paths and data transmitting (TX) paths for the independent links. As shown in FIGS. 4A-B, the modules along the data receiving (RX) path for one link are positioned in a mirrored configuration with respect to the modules along the data receiving (RX) path for the other link. Likewise, the modules along the data transmitting (TX) path for one link are positioned in a mirrored configuration with respect to the modules along the data transmitting (TX) path for the other link.

In FIG. 4A, the port 330 includes a PMA Rx 402 and a PMA Tx 404, and the PCS sublayer 332 includes a block alignment module 406, an elastic buffer 408 and an encode/loopback module 410. As shown, the block alignment module 406 and the elastic buffer 408 are on a data receiving (RX) path of the PCS sublayer 332. The encode/loopback module 410 is on a data transmitting (TX) path of the PCS sublayer 332.

Additionally, the MAC sublayer 334 of FIG. 4A includes two sets of data path function modules and a Link Training and Status State Machine (LTSSM) module 438. The LTSSM module 438 generally manages the initialization and configuration of its associated link, such as link width negotiation, data rate negotiation, equalization to ensure a stable and reliable connection between devices. One data path corresponds to a data receiving (RX) path having a precode module 412, a gray decode module 414, a descrambler module 416, a deskew module 418, a Non-Flit Mode (NFM) TLP digest (TD) & marker module 420, a Flit Mode (FM) CRC & FEC check module 422, and a multiplexer 424. The other data path corresponds to a data transmitting (TX) path having a precode module 426, a gray encode module 428, a scrambler module 430, a lane striping module 432, a multiplexer 434, and a FM TX retry & buffer module 436.

The data link layer 214 includes two sets of data path function modules and a link Finite State Machine (FSM) module 444, which manages and controls behavior of its associated link. One data path corresponds to a data receiving (RX) path having a TLP check and discard module 440 and a Data Link Layer Packet (DLLP) check module 442. The other data path corresponds to a data transmitting (TX) path having a DLLP generator 446 and a NFM TX retry & buffer module 448.

In FIG. 4B, the port 336 includes a PMA Tx 450 and a PMA Rx 452, and the PCS sublayer 338 includes an encode/loopback module 454 in a data transmitting (TX) path, and a block alignment module 456 and an elastic buffer 458 in a data receiving (RX) path. Additionally, the MAC sublayer 340 of FIG. 4B includes two sets of data path function modules and a LTSSM module 486. Like the LTSSM module 438, the LTSSM module 486 generally manages the initialization and configuration of its associated link, such as link width negotiation, data rate negotiation, equalization to ensure a stable and reliable connection between devices. One data path corresponds to a data transmitting (TX) path having a precode module 460, a gray encode module 462, a scrambler module 464, a lane striping module 466, a multiplexer 468, and a FM TX retry & buffer module 470. The other data path corresponds to a data receiving (RX) path having a precode module 472, a gray encode module 474, a descrambler module 476, a deskew module 478, a FM CRC & FEC check module 480, a NFM TD & marker module 482, and a multiplexer 484. The data link layer 218 includes two sets of data path function modules and a link FSM module 492, which manages and controls behavior of its associated link. One data path corresponds to a data transmitting (TX) path having a NFM TX retry & buffer module 488 and a DLLP generator 490. The other data path corresponds to a data receiving (RX) path having a DLLP check module 494 and a TLP check and discard module 496.

In FIGS. 4A-B, the data link layers 214, 218 are communication with each other and portions of the MAC sublayers 334, 340. For example, the TLP check and discard module 440 in the data link layer 214 passes data (e.g., TLPs) to the NFM TX retry & buffer module 488 in the data link layer 218 and to the FM TX retry & buffer module 470 in the MAC sublayer 340. Additionally, the TLP check and discard module 496 in the data link layer 218 passes data (e.g., TLPs) to the NFM TX retry & buffer module 448 in the data link layer 214 and to the FM TX retry & buffer module 436 in the MAC sublayer 334. Further, the DLLP check module 442 in the data link layer 214 passes data (e.g., DLLPs) to the DLLP generator 490 in the data link layer 218 via a remote fiber channel (FC), and the DLLP check module 494 in the data link layer 218 passes data (e.g., DLLPs) to the DLLP generator 446 in the data link layer 214 via another remote FC. The DLLP check module 442 and the DLLP generator 446 communicate via a local FC, and the DLLP check module 494 and the DLLP generator 490 communicate via another local FC.

During operation, data (e.g., TLPs) is received via the PMA Rx 402, 452 and passed to the block alignment modules 406, 456 and the elastic buffers 408, 458 of the PCS sublayers 332, 338. The block alignment modules 406, 456 generally synchronize data transmission so that proper data blocks can be interpreted. The elastic buffers 408, 458 are employed to compensate for time differences (e.g., between a recovered clock and a local clock). Data is then passed through the data path function modules associated with the MAC sublayers 334, 340.

For example, the precode modules 412, 472 receives and precodes scrambled data bits from the elastic buffers 408, 458. Then, the gray decodes modules 414, 474 generally convert data bits in a gray code format (e.g., a binary numeral system where two successive values differ by only one it) back into an equivalent binary representation. The descrambler modules 416, 476 then unscrambles the data (e.g., restores the data stream to its original form). Next, the data is passed to the deskew modules 418, 478, which align the data across multiple lanes to compensate for lane-to-lane skew. The data is then passed to the NFM TD & marker modules 420, 482 and the FM CRC & FEC check modules 422, 480 in the MAC sublayers 334, 340, before passing through the multiplexers 424, 484.

Each FM CRC & FEC check module 422, 480 implements a retry buffer, a Forward Error Correction (FEC) and a Cyclic Redundancy Check (CRC). For example, the FEC adds redundant data to a data stream, enabling detection and correction of errors without needing retransmission. The CRC is another error detection tool that calculates a value (e.g., a checksum) for the data, which is then sent along with the data and compared to a similarly calculated value downstream. The retry buffer can store retransmitted affected data (e.g., data with detected errors). Each NFM TD & marker module 420, 482 implements TLP and DLLP markers that define boundaries of passing TLPs and DLLPs.

Data is then passed from the multiplexers 424, 484 to the TLP check and discard modules 440, 496 and the DLLP check modules 442, 494 in the data link layers 214, 218. The DLLP check modules 442, 494 perform a validation process to verify the integrity of the received DLLPs. The TLP check and discard modules 440, 496 perform a validation process to verify the integrity of the received TLPs. If a fatal error exists in an TLP, that packet can be discarded.

Data (e.g., TLPs) is then passed from one data link layer 214, 218 to the other data link layer 214, 218 via the remote FCs. Specifically, data is passed from the DLLP check module 442, 494 in one data link layer 214, 218 to the DLLP generator 446, 490 of the other data link layer 214, 218. Additionally, data is passed from the TLP check and discard module 440, 496 in one data link layer 214, 218 to the NFM TX retry & buffer module 448, 488 of the other data link layer 214, 218. With this transition, the data passes from a receiving (Rx) path of one link to a transmitting (TX) path of the other link.

In their respective transmitting (TX) path, the DLLP generators 446, 490 create DLLPs. The created DLLPs are then passed from the DLLP generators 446, 490 to the FM TX retry & buffer modules 436, 470 in the MAC sublayers 334, 340 and to the NFM TX retry & buffer modules 448, 488 in the data link layer 214. Additionally, each FM TX retry & buffer module 436, 470 and each NFM TX retry & buffer module 448, 488 implements a TLP sequence number process, a CRC, and a retry buffer. The TLP sequence number process adds a sequence number to a TLP having a non-fatal error. The CRC calculates a value (e.g., a checksum) for the data, which is then sent along with the data and compared to a similarly calculated value downstream. The retry buffer can store retransmitted affected data (e.g., data with detected errors), as explained above. Then, data is then passed from the FM TX retry & buffer modules 436, 470 and the NFM TX retry & buffer modules 448, 488 and through the multiplexers 434, 468 in the MAC sublayers 334, 340.

Data is then passed through the lane striping modules 432, 466, the scrambler modules 430, 464, the gray encode modules 428, 462 and the precode modules 426, 460 in the MAC sublayers 334, 340. For example, each lane striping module 432, 466 distribute data packets (e.g., TLPs and DLLPs) across multiple lanes of its link. The scrambler modules 430, 464 randomize (or scrambles) the data stream before transmission. The gray encode modules 428, 462 convert data bits into a gray code format (e.g., a binary numeral system where two successive values differ by only one it), and the precode modules 426, 460 precodes scrambled data bits. Data is then passed to the encode/loopback modules 410, 454 in the transmitting (TX) path of the PCS sublayers 332, 338. The encode/loopback modules 410, 454 tests the passing data by sending encoded data and receiving the same data back for verification. Then, data is passed to the PMA Tx 404, 450 before flowing to the root complex and the endpoint.

Additionally, and as shown in FIG. 4A, the gearbox 400 includes a control module 498 that may function in a similar manner as the control module 342 of FIG. 3. For example, the control module 498 may include a CSR for storing information about a control state and controlling rate matching for data passing through the data link layers 214, 218. Further, in some embodiments, the control module 342 can detect errors on the data link layers 214, 218 and/or the physical layers 212, 216.

For example, the PCIe specification has defined components (e.g., root complexes, retimers, switches, endpoints, etc.) and defined functionality for each of the defined components. A gearbox, such as any one of the gearboxes disclosed herein, is not a defined component in the PCIe specification. However, components can interoperate with other PCIe compliant component in a computing system if the components are compliant with the PCIe specification. As such, the gearbox 400 (or any other gearbox disclosed herein) can function to ensure that they do not cause interoperability issues when used. In other words, the gearbox 400 can function as if it does not exist (e.g., is invisible) in the computing system with the PCIe compliant components. Thus, and as further explained below, the gearbox 400 can be designed to handle different PCIe-related functions without causing any issues.

The gearbox 400 can be designed to handle challenges associated with bandwidth matching and errors (e.g., physical layer errors, data link layer errors, etc.). For example, because the gearbox 400 does not have a transaction layer with a transaction layer buffer, the gearbox 400 cannot throttle received TLPs. For the gearbox 400 to function as if it does not exist, bandwidth on each of the links has to match so that TLPs that pass link layer checks (e.g., the CRC in the NFM TD & marker modules 420, 482, the FEC and the CRC in the FM CRC & FEC check modules 422, 480) on the data receiving (RX) path can be sent out on the transmitting (TX) path without any throttling.

For instance, the gearbox 400 may prevent link segments between an upstream PCIe component (e.g., a root complex, etc.) and the gearbox 400 and between the gearbox 400 and a downstream PCIe component (e.g., an endpoint, etc.) from entering a DL_Active state unless bandwidth on the link segments match. In a DL_Active state, the data link layers 214, 218 are active and ready for packet transmission. With this approach, the control module 498 can determine whether a bandwidth on a link between an upstream PCIe component and the gearbox 400 and a bandwidth on another link between the gearbox 400 and a downstream PCIe component is the same. If the bandwidths are different, the control module 498 or another suitable module (e.g., the link FSM modules 444, 492) can prevent the DLLP to pass between the root complex and the endpoint via the gearbox 400. This may be accomplished by, for example, preventing the gearbox 400 from entering a DL_Active state.

In response to the bandwidths being the same (or matching), the control module 498 can allow the gearbox 400 to enter a DL_Active state and packets (e.g., DLLPs) to pass between the root complex and the endpoint via the gearbox 400. In such examples, the control module 498 can transition one or both links into a recovery/configuration mode in an attempt to match bandwidth on both link segments. Once the bandwidth on the link segments match, the gearbox 400 will allow DLLPs to pass through, which causes link segments between upstream and downstream components and the gearbox 400 to enter a DL_Active state.

Additionally, once the links are active (e.g., in a DL_Active state), errors (e.g., a bit error rate (BER), etc.) on one or both link segments may occur. Such errors are often transient error conditions corrected through a recovery period. During this time, a transmitting (TX) path is blocked. As such, traffic through the gearbox 400 can be temporarily stalled during this recovery period. Thus, the control module 498 or another suitable module in the gearbox 400 may detect a transient error condition (e.g., a BER, etc.) on one of the links. In response to detecting the transient error condition, the control module 498 (or one of the link FSM modules 444, 492) can send a Negative Acknowledgement (NAK) signal on the other (active) link for received packets. In some examples, a longer recovery may cause a replay number rollover in the active link. As such, the gearbox 400 may set a replay number rollover as a non-fatal error. This enables the recovery period to continue operating.

Further, once the links are active, one of the link FSM modules 444, 492 may detect a link down condition associated with its link. For instance, a downstream link FSM module may detect a link down condition due to, for example, an endpoint being removed (e.g., a surprise hot plug), a link may become bad causing the downstream LTSSM module to be unable to link up, etc. In such examples, if the downstream link FSM module (e.g., the link FSM module 444) detects a link down condition on the downstream link segment, the upstream LTSSM module (e.g., the LTSSM module 486) can create a down condition on the upstream link segment.

In other examples, an upstream link FSM module (e.g., the link FSM module 492) may detect a link down condition. This may occur if, for example, the upstream LTSSM module fails to link up, fails to detect a state, etc. In response to the upstream link FSM module detecting the link down condition, the downstream LTSSM module (e.g., the LTSSM module 438) can enter a disabled state.

The gearbox 400 can also be designed to handle challenges associated with low power support. For example, PCIe links can be in between different power states to manage power consumption. The power states may include an active (or normal power) state (L0), an idle (or low-latency standby) state (L0s), a low-power (or standby) state (L1), low power substates (L1 SS), a dynamically adjustable state (L0p), a sleep state (L2), and a link off state (L3). In such examples, a power state entry may be initiated by downstream and upstream components (e.g., a root complex, an endpoint, etc.).

For instance, a downstream component may initiate entry into a lower-power state (L1). In such examples, the gearbox 400 can accept a lower-power request if there are no TLPs to be forwarded in the downstream transmitting (TX) path. As such, the control module 498 can enable a low power state (L1) for the link associated with the downstream component if no TLPs are present in that link.

Then, once the downstream link is in the low power state (L1), a request may be initiated towards the upstream component. For example, after the downstream link is in the low power state (L1), the control module 498 can initiate a low power state (L1) request for the upstream component (e.g., the root complex, etc.) connected with the upstream link. The upstream component may accept or reject the low power state (L1) request. If rejected, the control module 498 can transition the downstream link back to an active state (L0).

Additionally, a power state exit may be initiated by downstream and upstream components (e.g., a root complex, an endpoint, etc.). For example, if the links are in a low power state (L1), either the upstream component or the downstream component may initiate a request to exit the low power state (L1), thereby causing its associated link to start transitioning out of the low power state (L1). In response to the request, the control module 498 can control the link to also start transitioning out of the low power state (L1).

Other power state transitions may be handled in a similar manner as the low power state (L1) entry and exit. For example, low power substates (L1 SS) may be managed in a similar manner as the low power state (L1). Additionally, active state (L0) entry and exit may be handed at the link segment level (e.g., similar to the behavior of a switch).

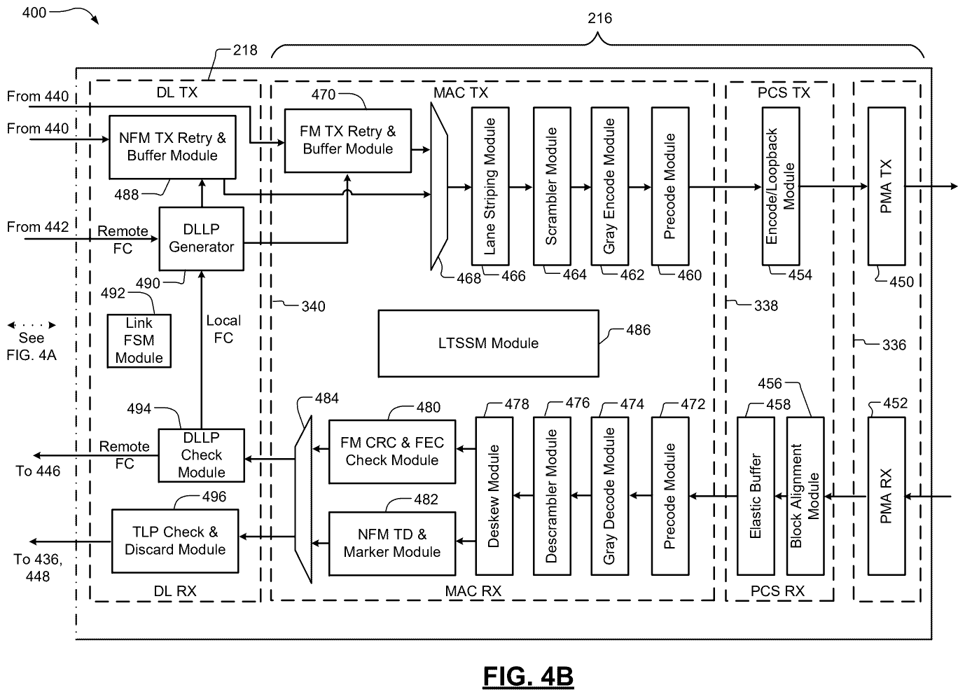

FIGS. 5-10 show control processes 500, 600, 700, 800, 900, 1000 enabling a gearbox to handle different PCIe-related functions. The operations of the control processes 500, 600, 700, 800, 900, 1000 are explained relative to the gearbox 400 of FIGS. 4A-B (e.g., the control module 498, the link FSM modules 444, 492, etc.). However, it should be appreciated that the operations of the control processes 500, 600, 700, 800, 900, 1000 may be implemented by any of the other gearboxes disclosed herein.

The control process 500 of FIG. 5 shows one example of addressing link down conditions on downstream link segments. In FIG. 5, the control process 500 begins at 502 by the control module 498 determining whether the downstream and upstream links are in active states (e.g., DL_Active states). If no, the control process 500 returns to 502. If yes, the control process 500 proceeds to 504.

At 504, the gearbox 400 determines whether a link down condition is detected on a downstream link segment. This detection may be made by a downstream link FSM module (e.g., the link FSM module 444) in the gearbox 400. If no, the control process 500 returns to 502. Otherwise, if yes at 504, the control process 500 proceeds to 506. At 510, an upstream LTSSM module (e.g., the LTSSM module 486) can create a surprise down condition on a upstream link segment.

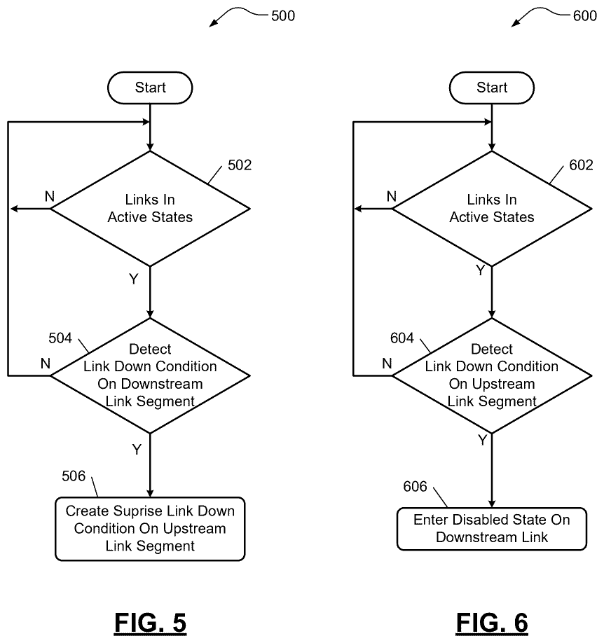

The control process 600 of FIG. 6 shows one example of addressing link down conditions on upstream link segments. In FIG. 6, the control process 600 begins at 602 by the control module 498 determining whether the downstream and upstream links are in active states (e.g., DL_Active states), as explained above. If no, the control process 600 returns to 602. If yes, the control process 600 proceeds to 604.

At 604, the gearbox 400 determines whether a link down condition is detected on an upstream link segment. This detection may be made by an upstream link FSM module (e.g., the link FSM module 492) in the gearbox 400. If no, the control process 600 returns to 602. Otherwise, if yes at 604, the control process 600 proceeds to 606. At 606, a downstream LTSSM module (e.g., the LTSSM module 438) enters a disabled state on the downstream link.

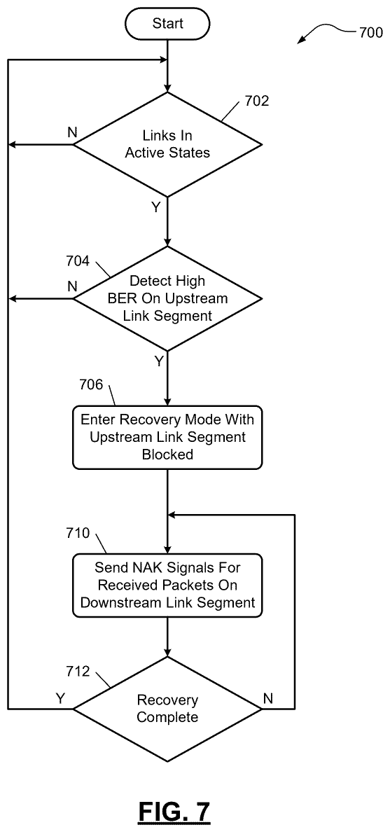

The control process 700 of FIG. 7 shows one example of addressing transient error conditions on upstream link segments. In FIG. 7, the control process 700 begins at 702 by the control module 498 determining whether the downstream and upstream links are in active states (e.g., DL_Active states), as explained above. If no, the control process 700 returns to 702. If yes, the control process 700 proceeds to 704.

At 704, the gearbox 400 detects whether an error condition (e.g., a transient error condition caused by a high BER, etc.) is present on an upstream link segment. If no, the control process 700 returns to 702. If yes at 704, the control process 700 proceeds to 706 where a recovery mode is entered with the upstream link segment blocked. The control process 700 then proceeds to 710.

At 710, NAKs are sent on the downstream link segment (e.g., the other, active link segment) for received packets. The control process 700 then proceeds to 712, where the gearbox 400 determines whether the recovery is complete. If yes, the control process 700 returns to 702. Otherwise, if no at 712, the control process 700 returns to 710.

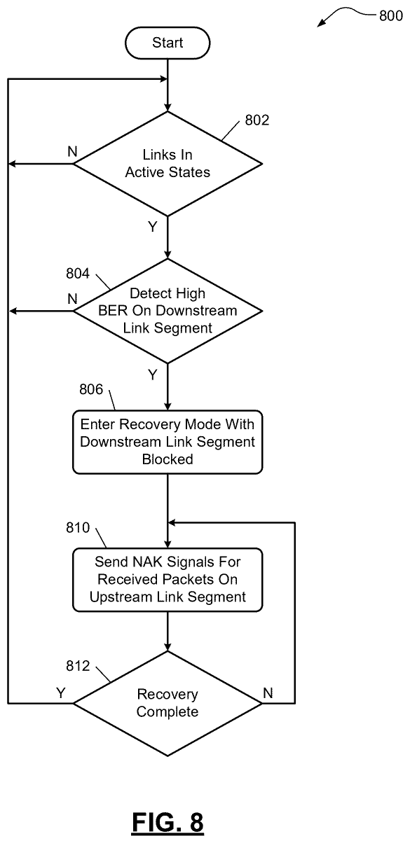

The control process 800 of FIG. 8 shows one example of addressing transient error conditions on downstream link segments. In FIG. 8, the control process 800 begins at 802 by the control module 498 determining whether the downstream and upstream links are in active states (e.g., DL_Active states), as explained above. If no, the control process 800 returns to 802. If yes, the control process 800 proceeds to 804.

At 804, the gearbox 400 detects whether an error condition (e.g., a transient error condition caused by a high BER, etc.) is present on a downstream link segment. If no, the control process 800 returns to 802. If yes at 804, the control process 800 proceeds to 806 where a recovery mode is entered with the downstream link segment blocked. The control process 800 then proceeds to 810.

At 810, NAKs are sent on the upstream link segment (e.g., the other, active link segment) for received packets. The control process 800 then proceeds to 812, where the gearbox 400 determines whether the recovery is complete. If yes, the control process 800 returns to 802. Otherwise, if no at 812, the control process 800 returns to 810.

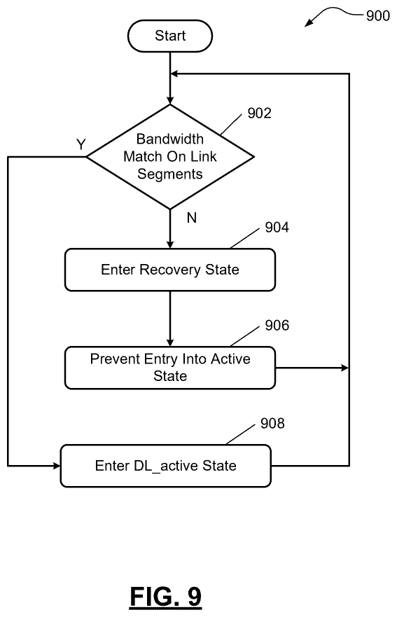

In FIG. 9, the control process 900 begins at 902 by the control module 498 determining whether bandwidths match on link segments connecting an upstream component and the gearbox 400 and connecting the gearbox 400 and a downstream component. If no, the control process 900 proceeds to 904, 906. At 904, the gearbox 400 enters a recovery state. At 906, the link segments are prevented from entering active states (e.g., DL_Active states). The control process 900 may then return to 902.

However, if yes at 902, the control process 900 proceeds to 908. At 908, the link segments are allowed to their DL_active states. As such, packets (e.g., DLLPs) are allowed to pass between the upstream and downstream components.

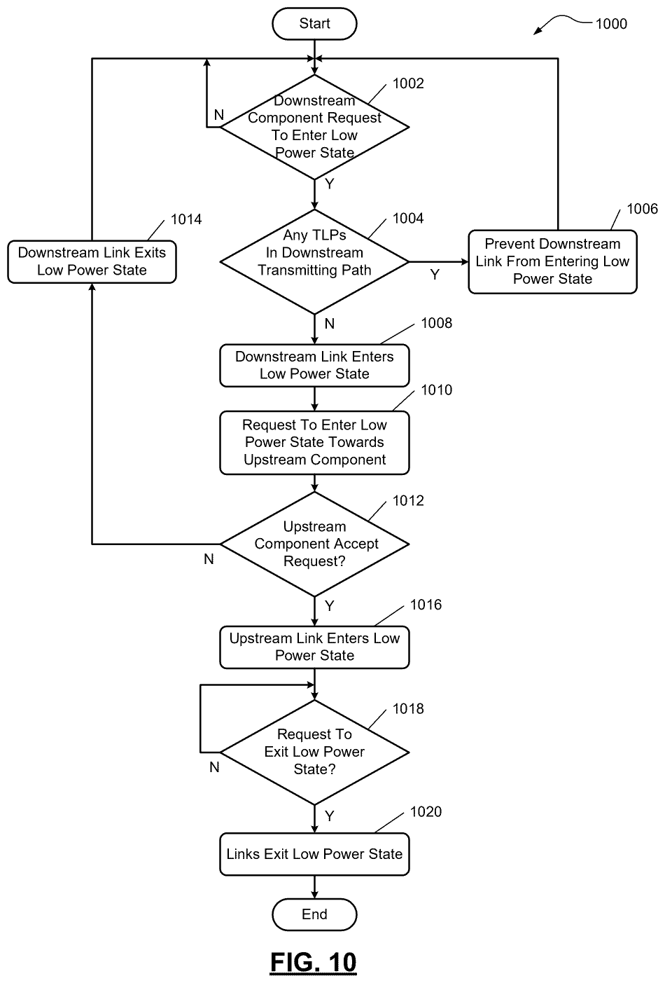

In FIG. 10, the control process 1000 begins at 1002 by the control module 498 determining whether a request to enter a low power state is received from a downstream component. If no, control process 1000 may then return to 1002. If yes, the control process 1000 proceeds to 1004.

At 1004, a determination is made as to whether any TLPs are present in the downstream transmitting (TX) path. If yes, the control process 1000 proceeds to 1006 where a downstream link is prevented from entering a low power state. The control process 1000 then may then return to 1002. If no at 1004, the control process 1000 proceeds to 1008 where the downstream link enters the low power state. Then, the control process 1000 proceeds to 1010.

At 1010, a request to enter a low power state is initiated towards the upstream component. The control process 1000 then proceeds to 1012, where the control module 498 determines whether the request is accepted by the upstream component. If no, the control process 1000 proceeds to 1014 where the downstream link exits the low power state. The control process 1000 may then return to 1002.

However, if yes at 1012, the control process 1000 proceeds to 1016. At 1016, the upstream link enters the low power state. The control process 1000 then proceeds to 1018, where the control module 498 determines whether a request to exit the low power state is received from the upstream component or the downstream component. If no, the control process 1000 returns to 1018. Otherwise, if either the upstream or downstream component request an exit the low power state, the upstream and downstream links exit the low power state at 1020. The control process 1000 may then end or return to 1002.

As explained above, the gearboxes herein provide the benefits of a switch and a retimer without the drawbacks associates with the switch and the retimer. As such, the gearboxes offer a hybrid component that can replace both switches and retimers in computing systems follow the PCIe communication standard or other related communication standards. For example, and as shown in Table 1 below, the gearboxes offer a low latency option similar to retimers. For example, latencies associated with the gearbox 400 may be (a) RX NFM Latency—PMA RX+PCS+MAC+DLL; (b) RX FM Latency—PMA RX+PCS+MAC; (c) RX to TX Interconnect Latency; and (d) TX FM/NFM Latency—DLL+MAC+PMA TX. Additionally, the gearboxes enable operation with the same or different bandwidths, the same or different data rates, and the same or different number of lanes, similar to switches. Further, similar to retimers, the gearboxes have reduced area requirements and associated costs.ss

TABLE 1

| Feature | Retimer | Switch | Gearbox |
|---|---|---|---|
| Latency | Low | High | Low |
| Area | Low | High | Low |
| Cost | Low | High | Low |
| Bandwidth | Same on both sides | Same or | Same on both sides |
| | (Highest common | different | (Highest bandwidth |
| | bandwidth between | | on each link |
| | link components) | | segment) |
| Number of lanes | Same on both sides | Same or | Same or different |
| on each side | | different | |
| of link | | | |
| Data rate on | Same on both sides | Same or | Same or different |
| each side | | different | |

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

In this application, apparatus elements described as having particular attributes or performing particular operations are specifically configured to have those particular attributes and perform those particular operations. Specifically, a description of an element to perform an action means that the element is configured to perform the action. The configuration of an element may include programming of the element, such as by encoding instructions on a non-transitory, tangible computer-readable medium associated with the element.

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A gearbox for connecting between a root complex and an endpoint in a computing device, the gearbox comprising:
a first port configured to connect to the root complex;
a second port configured to connect to the endpoint;
a first physical layer connected to the first port and a second physical layer connected to the second port; and
a first data link layer and a second data link layer, the first data link layer connected between the second data link layer and the first physical layer, and the second data link layer connected between the first data link layer and the second physical layer,
wherein the first physical layer, the first data link layer, the second physical layer, and the second data link layer are configured to form one or more lanes for communicating data between the root complex and the endpoint.

2. The gearbox of claim 1, wherein:
the first physical layer and the first data link layer form a first link; and
the second physical layer and the second data link layer form a second link independent from the first link.

3. The gearbox of claim 2, wherein:
the first physical layer includes a physical coding sublayer (PCS) connected to the first port and a media access control (MAC) sublayer connected to the first data link layer; and
the second physical layer includes a PCS connected to the second port and a MAC sublayer connected to the second data link layer.

4. The gearbox of claim 3, wherein:
the PCS of the first physical layer is configured to provide a data interface between the first port and the MAC sublayer; and
the PCS of the second physical layer is configured to provide a data interface between the second port and the MAC sublayer of the second physical layer.

5. The gearbox of claim 3, wherein:
the MAC sublayer of the first physical layer includes data path modules between the PCS of the first physical layer and the first data link layer, and a first Link Training and Status State Machine (LTSSM) module; and
the MAC sublayer of the second physical layer includes data path modules between the PCS of the second physical layer and the second data link layer, and a second LTSSM module.

6. The gearbox of claim 5, wherein:
the first data link layer includes a first finite state machine (FSM) module configured to connect with the second link; and
the second data link layer includes a second FSM module configured to connect with the first link.

7. The gearbox of claim 6, wherein:
the second FSM module is configured to detect a link down condition on the second link; and
in response to the link down condition, the first LTSSM module is configured to create a link down condition on the first link.

8. The gearbox of claim 6, wherein:
the first FSM module is configured to detect a link down condition on the first link; and
in response to the link down condition, the second LTSSM module is configured to enter a disabled state.

9. The gearbox of claim 6, further comprising a control module configured to:
determine whether a bandwidth on the first link and a bandwidth on the second link is the same; and
in response to the bandwidth on the first link and the bandwidth on the second link being the same, allow a Data Link Layer Packet (DLLP) to pass between the root complex and the endpoint via the gearbox.

10. The gearbox of claim 9, wherein the control module is configured to prevent the DLLP to pass between the root complex and the endpoint via the gearbox in response to the bandwidth on the first link and the bandwidth on the second link being different.

11. The gearbox of claim 6, further comprising a control module configured to:
detect a transient error condition on one of the first link or the second link; and
in response to the transient error condition, send a Negative Acknowledgement (NAK) signal on the other one of the first link or the second link.

12. The gearbox of claim 6, further comprising a control module configured to enable a low power state for one of the first link or the second link if no Transaction Layer Packets (TLPs) are present in the one of the first link or the second link.

13. The gearbox of claim 12, wherein the control module is configured to:
initiate a low power state request for the root complex or the endpoint connectable to the other one of the first link or the second link; and
in response to the low power state request being rejected, transition the one of the first link or the second link back to an active state.

14. The gearbox of claim 12, wherein the control module is configured to exit the low power state in response to a request for the root complex or the endpoint.

15. The gearbox of claim 2, wherein a bandwidth on the first link and a bandwidth on the second link are the same.

16. The gearbox of claim 2, wherein a data rate at the first port is different than a data rate at the second port.

17. The gearbox of claim 2, wherein a data rate at the first port is the same as a data rate at the second port.

18. The gearbox of claim 1, wherein the gearbox does not include a transaction layer.

19. The gearbox of claim 1, wherein the gearbox is configured to communicate data, compliant with a Peripheral Component Interconnect Express (PCIe) standard, between the root complex and the endpoint.

20. A computing system for communicating data compliant with a Peripheral Component Interconnect Express (PCIe) standard, the computing system comprising:
a root complex configured to connect to a processor and memory;
an endpoint; and
a gearbox connected between the root complex and the endpoint, the gearbox including a first port connected to the root complex and a second port connected to the endpoint, the gearbox configured to communicate data, compliant with the Peripheral Component Interconnect Express (PCIe) standard, between the root complex and the endpoint.

21. The computing system of claim 20, wherein the gearbox includes:
a first physical layer connected to the first port;
a second physical layer connected to the second port;
a first data link layer and a second data link layer;
the first data link layer is connected between the second data link layer and the first physical layer;
the second data link layer is connected between the first data link layer and the second physical layer; and
the first physical layer, the first data link layer, the second physical layer, and the second data link layer are configured to form one or more lanes for communicating data between the root complex and the endpoint.

22. The computing system of claim 21, wherein the first physical layer and the first data link layer form a first link, and the second physical layer and the second data link layer form a second link independent from the first link.

23. The computing system of claim 21, wherein:
the first physical layer includes a physical coding sublayer (PCS) connected to the first port and a media access control (MAC) sublayer connected to the first data link layer;
the second physical layer includes a PCS connected to the second port and a MAC sublayer connected to the second data link layer;
the PCS of the first physical layer is configured to provide a data interface between the first port and the MAC sublayer; and
the PCS of the second physical layer is configured to provide a data interface between the second port and the MAC sublayer of the second physical layer.

24. The computing system of claim 23, wherein:
the MAC sublayer of the first physical layer includes data path modules between the PCS of the first physical layer and the first data link layer, and a first Link Training and Status State Machine (LTSSM) module;
the MAC sublayer of the second physical layer includes data path modules between the PCS of the second physical layer and the second data link layer, and a second LTSSM module;
the first data link layer includes a first finite state machine (FSM) module configured to connect with the second link; and
the second data link layer includes a second FSM module configured to connect with the first link.

25. The computing system of claim 24, wherein:
the second FSM module is configured to detect a link down condition on the second link; and
in response to the link down condition, the first LTSSM module is configured to create a link down condition on the first link.

26. The computing system of claim 24, wherein:
the first FSM module is configured to detect a link down condition on the first link; and
in response to the link down condition, the second LTSSM module is configured to enter a disabled state.

27. The computing system of claim 24, wherein the gearbox further includes a control module configured to:
determine whether a bandwidth on the first link and a bandwidth on the second link is the same; and
in response to the bandwidth on the first link and the bandwidth on the second link being the same, allow a Data Link Layer Packet (DLLP) to pass between the root complex and the endpoint via the gearbox.

28. The computing system of claim 27, wherein the control module is configured to prevent the DLLP to pass between the root complex and the endpoint via the gearbox in response to the bandwidth on the first link and the bandwidth on the second link being different.

29. The computing system of claim 24, wherein the gearbox further includes a control module configured to:
detect a transient error condition on one of the first link or the second link; and
in response to the transient error condition, send a Negative Acknowledgement (NAK) signal on the other one of the first link or the second link.

30. The computing system of claim 24, wherein the gearbox further includes a control module configured to:
enable a low power state for one of the first link or the second link if no Transaction Layer Packets (TLPs) are present in the one of the first link or the second link;
initiate a low power state request for the root complex or the endpoint connected to the other one of the first link or the second link; and
in response to the low power state request being rejected, transition the one of the first link or the second link back to an active state.

31. The computing system of claim 30, wherein the control module is configured to exit the low power state in response to a request for the root complex or the endpoint.

32. The computing system of claim 22, wherein a bandwidth on the first link and a bandwidth on the second link are the same.

33. The computing system of claim 22, wherein a data rate at the first port is different than a data rate at the second port.

34. The computing system of claim 22, wherein a data rate at the first port is the same as a data rate at the second port.

35. The computing system of claim 20, wherein the gearbox does not include a transaction layer.

36. A computing system for communicating data, the computing system comprising:
a root complex configured to connect to a processor and memory;
an endpoint; and
a gearbox connected between the root complex and the endpoint, the gearbox including a first port connected to the root complex and a second port connected to the endpoint, a first physical layer connected to the first port and a second physical layer connected to the second port, and a first data link layer and a second data link layer, the first data link layer connected between the second data link layer and the first physical layer, and the second data link layer connected between the first data link layer and the second physical layer,
wherein the first physical layer, the first data link layer, the second physical layer, and the second data link layer are configured to form one or more lanes for communicating data between the root complex and the endpoint.

37. The computing system of claim 36, wherein a data rate at the first port is different than a data rate at the second port.

38. The computing system of claim 36, wherein a data rate at the first port is the same as a data rate at the second port.
